(19) United States
(12) Patent Application Publication
(10) Pub. No.: US 2020/0238203 A1
(43) Pub. Date: Jul. 30, 2020

(54) Filtering and Pumping Assembly

(71) Applicant: Daniel Kunst, Eau Claire, MI (US)

(72) Inventor: Daniel Kunst, Eau Claire, MI (US)

(21) Appl. No.: 16/260,240

(22) Filed: Jan. 29, 2019

(51) Int. Cl. B01D 29/11; B01D 29/23; A01K 63/04

(52) U.S. Cl. CPC B01D 29/111; A01K 63/04; B01D 29/23

(57) ABSTRACT

A filtering and pumping assembly for reducing pump maintenance includes a shell, which is meshed and defines an interior space. A power module and a pump, which is operationally coupled to the power module, are coupled to the shell and positioned in the interior space. A pipe is coupled to and extends from an exit port of the pump through an aperture positioned in a top of the shell. A plurality of fasteners is coupled to the shell and is configured to couple the shell to an element of a water feature so that the pump is positioned below a surface of water that in the water feature and so that the pipe extends above the surface. The shell is configured to filter debris from water that enters the interior space and an intake port of the pump. The pump is configured to discharge the water from the pipe.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### Description of Related Art Including Information Disclosed Under 37 CFR 1.97 and 1.98.

The disclosure and prior art relates to pumping assemblies and more particularly pertains to a new pumping assembly for reducing pump maintenance.

### BRIEF SUMMARY OF THE INVENTION

An embodiment of the disclosure meets the needs presented above by generally comprising a shell, which is meshed and defines an interior space. A power module and a pump, which is operationally coupled to the power module, are coupled to the shell and positioned in the interior space. A pipe is coupled to and extends from an exit port of the pump through an aperture positioned in a top of the shell. A plurality of fasteners is coupled to the shell and is configured to couple the shell to an element of a water feature so that the pump is positioned below a surface of water that in the water feature and so that the pipe extends above the surface. The shell is configured to filter debris from water that enters the interior space and an intake port of the pump. The pump is configured to discharge the water from the pipe.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a filtering and pumping assembly according to an embodiment of the disclosure.

FIG. 2 is an isometric perspective view of an embodiment of the disclosure.

FIG. 3 is a cross-sectional view of an embodiment of the disclosure.

FIG. 4 is a bottom view of an embodiment of the disclosure.

FIG. 5 is an in-use view of an embodiment of the disclosure.

### DETAILED DESCRIPTION OF THE INVENTION

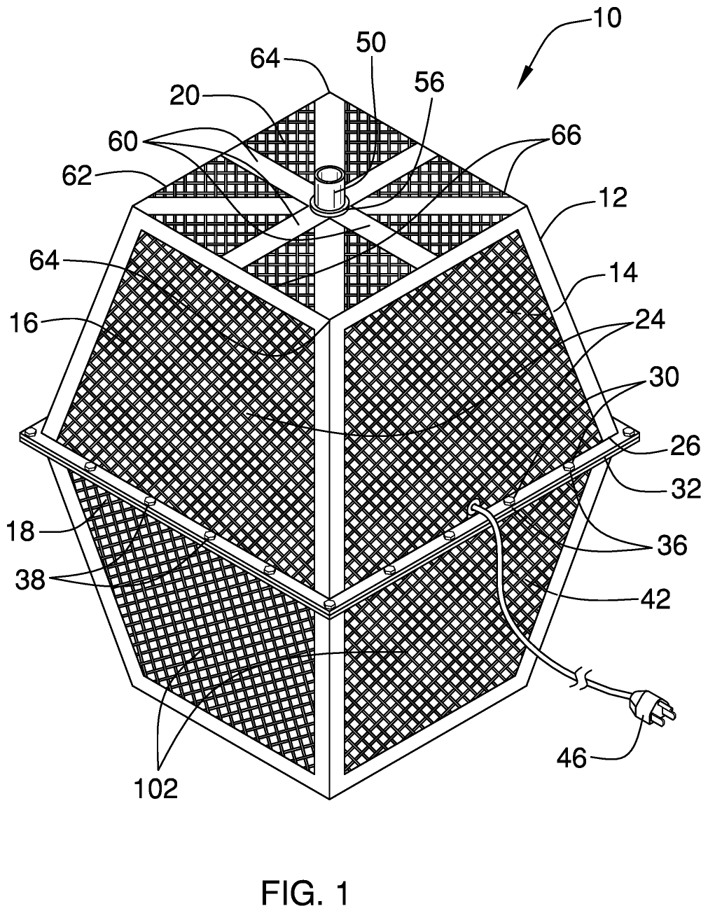

With reference now to the drawings, and in particular to FIGS. 1 through 5 thereof, a new pumping assembly embodying the principles and concepts of an embodiment of the disclosure and generally designated by the reference numeral 10 will be described.

As best illustrated in FIGS. 1 through 5, the filtering and pumping assembly 10 generally comprises a shell 12 that define an interior space 14. The shell 12 is meshed. The shell 12 comprises an upper section 16 and a lower section 18, which are both square frustum shaped so that a top 20 and a bottom 22 of the shell 12 are squarely shaped and faces 24 of the upper section 16 and faces 102 of the lower section 18 are trapezoidally shaped, as shown in FIG. 1.

A first rim 26 is coupled to and extends from a lower circumference 28 of the upper section 16. A plurality of first holes 30 is positioned in the first rim 26. A second rim 32 is coupled to and extends from an upper circumference 34 of the lower section 18. A plurality of second holes 36 is positioned in the second rim 32 so that each second hole 36 is aligned with a respective first hole 30. Each of a plurality of upper bolts 38 is positioned through a respective first hole 30 and an associated second hole 36. Each of a plurality of upper nuts 40 is threadedly coupled to a respective upper bolt 38 so that the upper section 16 is coupled to the lower section 18.

A power module 42 is coupled to the shell 12 and is positioned in the interior space 14. The power module 42 comprises a power cord 44 that extends from the interior space 14 through the shell 12 so that a plug 46 of the power cord 44 is configured to couple to a source of electrical current.

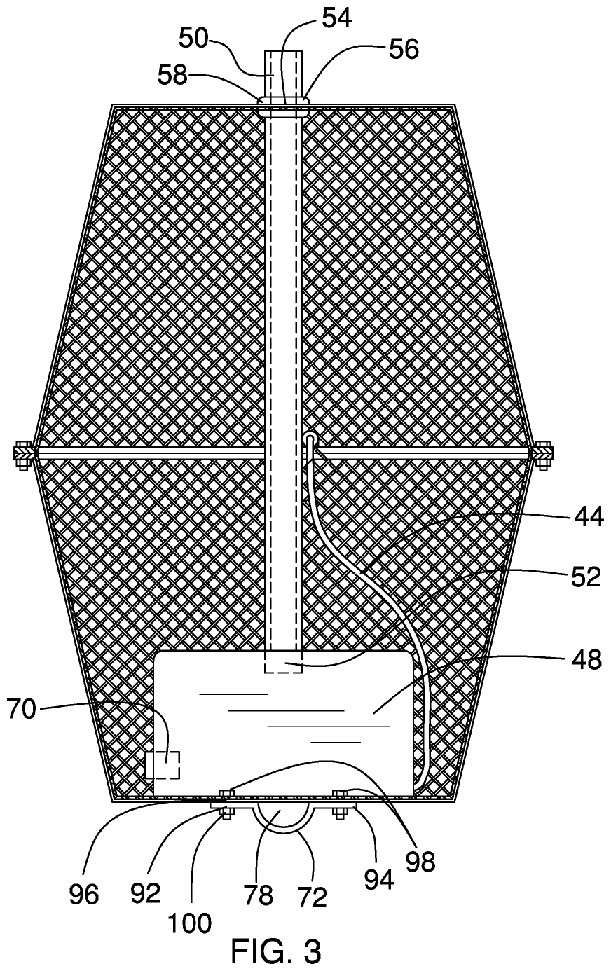

A pump 48 is coupled to the bottom 22 of the shell 12 and is positioned in the interior space 14. The pump 48 is operationally coupled to the power module 42. A pipe 50 is coupled to and extends from an exit port 52 of the pump 48 through an aperture 54 that is positioned in the top 20 of the shell 12, as shown in FIG. 3. A ring 56 is coupled to a perimeter 58 of the aperture 54.

Each of a plurality of upper bars 60 is coupled to and extends between the ring 56 and a perimeter 62 of the top 20, as shown in FIG. 1. The upper bars 60 are positioned to stabilize the pipe 50 relative to the shell 12. The plurality of upper bars 60 comprises upper bars 60 that extend singly from opposing corners 64 of the top 20 to the ring 56 and from opposing sides 66 of the top 20 to the ring 56.

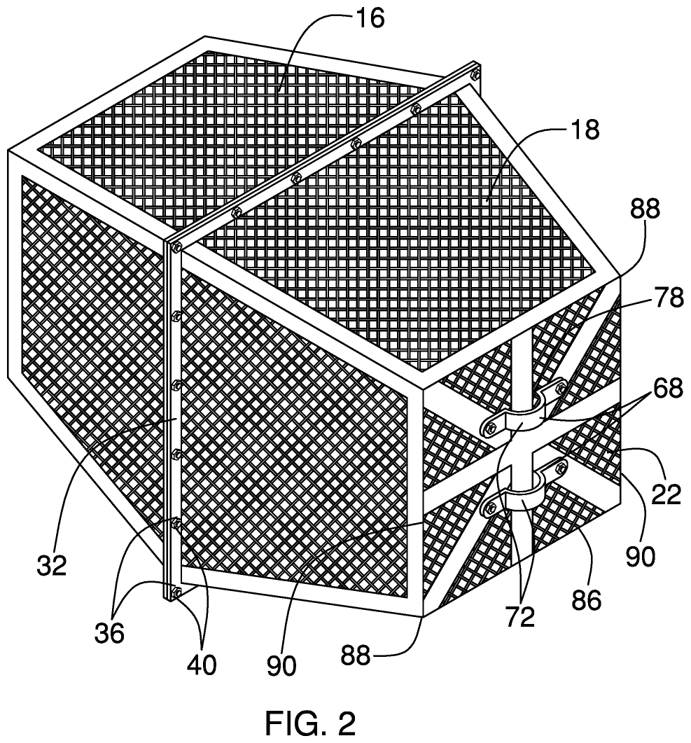

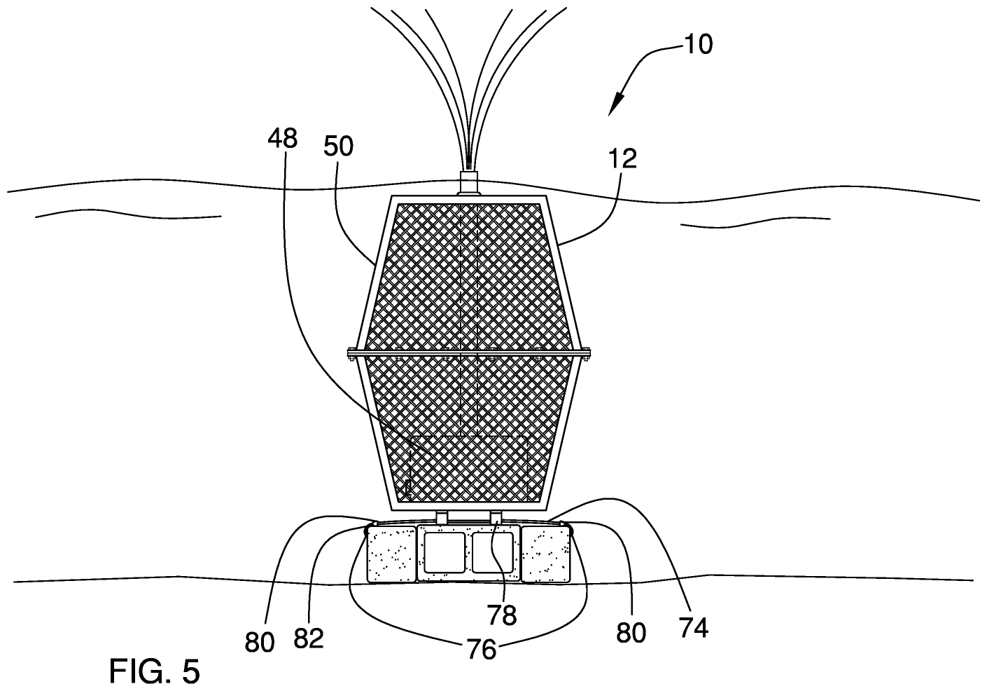

A plurality of fasteners 68 is coupled to the shell 12, as shown in FIG. 2. The fasteners 68 are configured to couple the shell 12 to an element of a water feature, as shown in FIG. 5, so that the pump 48 is positioned below a surface of water that is positioned in the water feature. The pipe 50 extends above the surface of the water in the water feature, such as a pond. The shell 12 is configured to filter debris, such as leaves, from water that enters the interior space 14 and an intake port 70 of the pump 48. The pump 48 is configured to discharge the water from the pipe 50.

Filtering of the debris helps prevent the pump 48 from plugging and reduces maintenance requirements for the pump 48. The faces 24 of the upper section 16 and the faces 102 of the lower section 18 of the shell 12, being angled relative to the top 20 and the bottom 22 of the shell 12, respectively, promote dropping of the debris from the shell 12 so that the water continues to flow into the interior space 14.

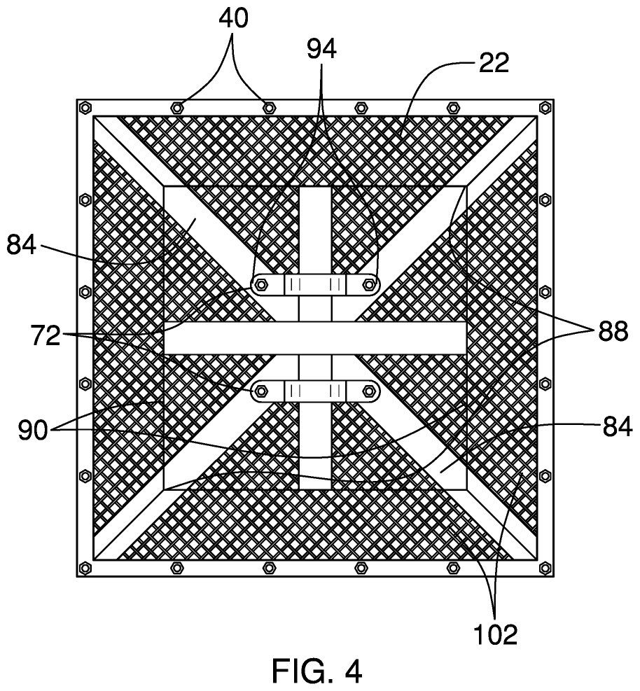

The plurality of fasteners 68 is positioned externally to the shell 12 on the bottom 22 of the shell 12, as shown in FIG. 4. The plurality of fasteners 68 comprises a pair of pipe straps 72, a tether 74, and a pair of connectors 76. Each pipe strap 72 is coupled to the bottom 22 of the shell 12 to define a respective slot 78. The tether 74 is positioned through the slots 78. The connectors 76 are coupled singly to opposing ends 80 of the tether 74. The connectors 76 are configured to couple the tether 74 to the element of the water feature so that the pump 48 is positioned below the surface of the water. Each connector 76 comprises a hook 82, and the tether 74 comprises elastomer so that the tether 74 is resiliently stretchable.

Each of a plurality of lower bars 84 is coupled to and extends between a perimeter 86 of the bottom 22, as shown in FIG. 4. The plurality of lower bars 84 comprises two lower bars 84 that extend singly between opposing corners 88 of the bottom 22 and two lower bars 84 that extend singly between opposing sides 90 of the bottom 22.

Each of a set of four first openings 92 is positioned in an associated pipe strap 72 proximate to a respective opposing endpoint 94 of the associated pipe strap 72. A set of four second openings 96 is positioned in the plurality of lower bars 84 so that each second opening 96 is aligned with a respective first opening 92. Each of a plurality of lower bolts 98 is positioned through a respective first opening 92 and an associated second opening 96. Each of a plurality of lower nuts 100 is threadedly is coupled to a respective lower bolt 98 so that the pipe straps 72 are coupled to the bottom 22 of the shell 12.

In use, the hooks 82 on the tether 74 are used to couple the shell 12 to the element of the water feature with the pump 48 positioned below the surface of the water and the pipe 50 extending above the surface. The shell 12 filters the debris from the water that enters the interior space 14 and an intake port 70 of the pump 48. The pump 48 discharges the water from the pipe 50.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A filtering and pumping assembly comprising:
a shell defining an interior space, the shell being meshed;
a power module coupled to the shell and positioned in the interior space;
a pump coupled to a bottom of the shell and positioned in the interior space, the pump being operationally coupled to the power module;
a pipe coupled to and extending from an exit port of the pump through an aperture positioned in a top of the shell; and
a plurality of fasteners coupled to the shell wherein the fasteners are configured for coupling the shell to an element of a water feature such that the pump is positioned below a surface of water positioned in the water feature and such that the pipe extends above the surface wherein the shell is configured for filtering debris from water entering the interior space and an intake port of the pump and wherein the pump is configured for discharging the water from the pipe.

2. The assembly of claim 1, further including the shell comprising an upper section and a lower section, the upper section and the lower section being square frustum shaped such that the top and a bottom of the shell are squarely shaped and faces of the upper section and faces of the lower section are trapezoidally shaped.

3. The assembly of claim 2, further comprising:
a first rim coupled to and extending from a lower circumference of the upper section;
a plurality of first holes positioned in the first rim;
a second rim coupled to and extending from an upper circumference of the lower section;
a plurality of second holes positioned in the second rim such that each second hole is aligned with a respective first hole;
a plurality of upper bolts, each upper bolt being positioned through a respective first hole and an associated second hole; and
a plurality of upper nuts, each upper nut being threadedly coupled to a respective upper bolt such that the upper section is coupled to the lower section.

4. The assembly of claim 1, further including the power module comprising a power cord extending from the interior space through the shell such that a plug of the power cord is configured for coupling to a source of electrical current.

5. The assembly of claim 1, further comprising:
a ring coupled to a perimeter of the aperture; and
a plurality of upper bars, each upper bar being coupled to and extending between the ring and a perimeter of the top wherein the upper bars are positioned for stabilizing the pipe relative to the shell.

6. The assembly of claim 5, further including the plurality of upper bars comprising upper bars extending singly from opposing corners of the top to the ring and from opposing sides of the top to the ring.

7. The assembly of claim 1, further including the plurality of fasteners being positioned externally to the shell on the bottom of the shell.

8. The assembly of claim 7, further including the plurality of fasteners comprising a pair of pipe straps, a tether, and a pair of connectors, each pipe strap being coupled to the bottom of the shell defining a respective slot, the tether being positioned through the slots, the connectors being coupled singly to opposing ends of the tether wherein the connectors are configured for coupling the tether to the element of the water feature such that the pump is positioned below the surface of the water.

9. The assembly of claim 8, further including each connector comprising a hook, the tether comprising elastomer such that the tether is resiliently stretchable.

10. The assembly of claim 8, further including a plurality of lower bars, each lower bar being coupled to and extending between a perimeter of the bottom.

11. The assembly of claim 10, further including the plurality of lower bars comprising two lower bars extending singly between opposing corners of the bottom and two lower bars extending singly between opposing sides of the bottom.

12. The assembly of claim 10, further comprising:
a set of four first openings, each first opening being positioned in an associated pipe strap proximate to a respective opposing endpoint of the associated pipe strap;
a set of four second openings positioned in the plurality of lower bars such that each second opening is aligned with a respective first opening;
a plurality of lower bolts, each lower bolt being positioned through a respective first opening and an associated second opening; and
a plurality of lower nuts, each lower nut being threadedly coupled to a respective lower bolt such that the pipe straps are coupled to the bottom of the shell.

13. A filtering and pumping assembly comprising:
a shell defining an interior space, the shell being meshed, the shell comprising an upper section and a lower section, the upper section and the lower section being square frustum shaped such that a top and a bottom of the shell are squarely shaped and faces of the upper section and faces of the lower section are trapezoidally shaped;
a first rim coupled to and extending from a lower circumference of the upper section;
a plurality of first holes positioned in the first rim;
a second rim coupled to and extending from an upper circumference of the lower section;
a plurality of second holes positioned in the second rim such that each second hole is aligned with a respective first hole;
a plurality of upper bolts, each upper bolt being positioned through a respective first hole and an associated second hole;
a plurality of upper nuts, each upper nut being threadedly coupled to a respective upper bolt such that the upper section is coupled to the lower section;
a power module coupled to the shell and positioned in the interior space, the power module comprising a power cord extending from the interior space through the shell such that a plug of the power cord is configured for coupling to a source of electrical current;
a pump coupled to the bottom of the shell and positioned in the interior space, the pump being operationally coupled to the power module;
a pipe coupled to and extending from an exit port of the pump through an aperture positioned in the top of the shell;
a ring coupled to a perimeter of the aperture;
a plurality of upper bars, each upper bar being coupled to and extending between the ring and a perimeter of the top wherein the upper bars are positioned for stabilizing the pipe relative to the shell, the plurality of upper bars comprising upper bars extending singly from opposing corners of the top to the ring and from opposing sides of the top to the ring;
a plurality of fasteners coupled to the shell wherein the fasteners are configured for coupling the shell to an element of a water feature such that the pump is positioned below a surface of water positioned in the water feature and such that the pipe extends above the surface wherein the shell is configured for filtering debris from water entering the interior space and an intake port of the pump and wherein the pump is configured for discharging the water from the pipe, the plurality of fasteners being positioned externally to the shell on the bottom of the shell, the plurality of fasteners comprising a pair of pipe straps, a tether, and a pair of connectors, each pipe strap being coupled to the bottom of the shell defining a respective slot, the tether being positioned through the slots, the connectors being coupled singly to opposing ends of the tether wherein the connectors are configured for coupling the tether to the element of the water feature such that the pump is positioned below the surface of the water, each connector comprising a hook, the tether comprising elastomer such that the tether is resiliently stretchable;
a plurality of lower bars, each lower bar being coupled to and extending between a perimeter of the bottom, the plurality of lower bars comprising two lower bars extending singly between opposing corners of the bottom and two lower bars extending singly between opposing sides of the bottom;
a set of four first openings, each first opening being positioned in an associated pipe strap proximate to a respective opposing endpoint of the associated pipe strap;
a set of four second openings positioned in the plurality of lower bars such that each second opening is aligned with a respective first opening;
a plurality of lower bolts, each lower bolt being positioned through a respective first opening and an associated second opening; and
a plurality of lower nuts, each lower nut being threadedly coupled to a respective lower bolt such that the pipe straps are coupled to the bottom of the shell.
